(19) United States
(12) Patent Application Publication
(10) Pub. No.: US 2021/0008546 A1
(43) Pub. Date: Jan. 14, 2021

(54) HAND-HELD DEVICES

(71) Applicant: National University of Singapore, Singapore (SG)

(72) Inventors: Dieter Wilhelm TRAU, Singapore (SG); Abhinav JAIN, Singapore (SG); Shihao LI, Singapore (SG)

(21) Appl. No.: 16/097,090

(22) PCT Filed: May 12, 2017
(86) PCT No.: PCT/SG2017/050249

§ 371 Date: Oct. 26, 2018

(30) Foreign Application Priority Data
May 12, 2016 (GB) 1608340.4

(51) Int. Cl. B01L 3/02; B01L 3/00

(52) U.S. Cl. CPC B01L 3/0275; B01L 2200/04; B01L 2200/025; B01L 3/508

(57) ABSTRACT

The invention concerns a hand-held device with a removable tip for dispensing an agent and/or sampling a fluid; a tip for use in connection therewith; wherein said tip is additionally provided with at least one abutment member located on the outside of said tip, and a container for use therewith which is adapted to facilitate the removal of tips from said device and to receive same for disposal. The invention further includes a method for attaching and ejecting a tip from said hand-held device by rotating the tip with respect to said device to bring about alignment of the alignment guides until a best fit is achieved; and ejecting the tip from the hand-held device by inserting the tip into said container and aligning said abutment member on said tip with the boundary corresponding to same in said aperture then rotating said tip with respect to said device to eject the tip from the device.

### FIELD OF THE INVENTION

The invention concerns a hand-held device with a removable tip for dispensing an agent and/or pipetting a fluid and/or receiving a sample for measurement purpose, a tip for use in connection therewith; and a container for use therewith which is adapted to facilitate the removal of tips from said device and to receive same for disposal.

### BACKGROUND OF THE INVENTION

More specifically, the current invention is related to a tip alignment and ejection mechanism for hand-held devices. In particular, but not exclusively, for hand-held laboratory devices such as pipettes, photometers, spectrometers, biosensors, diagnostic devices or, any other type of device that requires a removable tip to be attached or detached.

Current hand-held laboratory devices such as automatic pipettes or hand-held photometer devices require the attachment of a pipetting tip or photometric measurement tip. In most cases such tips are disposable. Typically, such tips are manually attached to a hand-held laboratory devices by aligning and pushing male-female ends of the device and the tips respectively. The tip and the device are held together by an interference-fit. After its intended use such as pipetting or a measurement, the tip is ejected from the device by manually detaching it or using a mechanical ejector. Current ejector mechanisms require a mechanical or electro-mechanical actuation using a finger or a thumb of the operator. Such actuation mechanically transfers down a push force which disrupts the interference-fit and resulting it detachment of the tip with the device. These mechanical or electro-mechanical actuation are widely used by most automatic commercially available hand-held devices, such as pipettes. However, they intrinsically involve greater engineering-design complexities and higher manufacturing capabilities. Such actuation also requires dexterity of at least a finger and an ergonomically friendlier design as the user have to create force using at least one finger. However, in certain cases the radial alignment of the device and measurement can be of prime importance, such as for example, the measurement tip of a hand-held photometer device. Existing engineering and design approaches for a precise radial alignment of a tip with a device are mechanically complex.

Thus, the current invention provides a novel yet simple mechanism to achieve axial and radial tip alignment for insertion and ejection for hand-held devices; preferentially but not limited to portable hand-held laboratory devices. The current invention also provides a comprehensive hand-help measurement system consisting of a hand-held device, self-aligning removable tip(s), and a used-tip container adapted to facilitate removal of a tip from said device and to receive same for disposal. In this present invention the same mechanism that is used to align the tip with the device is also used to eject the tip from the device.

### STATEMENTS OF THE INVENTION

According to a first aspect, there is provided a hand-held device with a removable tip for dispending an agent and/or pipetting a fluid and/or receiving a sample for measurement purpose, comprising:

a device body terminating in a member that is circular in cross-section and sized and shaped to frictionally hold said tip and wherein said member is further provided with at least one alignment guide;

a removable tip that is at least partially hollow and whose inner surface is sized and shaped to frictionally fit with said member and which is further also provided with at least one alignment guide;

wherein said alignment guides comprise complimentary features that when brought together and rotated, one with respect to the other, result in alignment of said tip with respect to said body.

In certain devices said tip is additionally provided with at least one abutment member located on the outside of said tip.

Reference herein to a device or hand-held device or laboratory device, or their plural, includes reference to a device used in laboratories such as but not limited to a pipetting device, a photometer or spectrometer, a sensor, a biosensor or a diagnostic device or, indeed, any other type of device that requires a removable tip in the form of a dispenser, sampler, probe or sensor. The device or hand-held device or laboratory device of this invention is not restricted to be used in laboratories, it may be used in the field, in the operation theatre, or in an ambulance, and is, typically but not exclusively, generally portable. The device or hand-held device or laboratory device may be applied as a research tool, in any appropriate industry such as but not limited to the diagnostics industry, the food and beverage industry, the chemical industry or for the environmental industry.

Reference herein to a tip or a plurality of tips includes reference to a dispensing or sampling tip, a pipetting tip, or a tip for optical measurements such as but not limited to photometric, spectrometric or fluorometric measurements, or a sensor tip to perform chemical analysis or diagnostic testing. The tip may be disposable or non-disposable.

It therefore follows that in certain devices said tip(s) is a dispenser or sampler or a probe or a sensor and, accordingly said tip is adapted to perform any one or more of the afore functions and, typically, but not always exclusively, said tip is best used with said device when it is positioned on same in an aligned fashion. In this context, alignment means the alignment of the tip, or a certain feature(s) thereof, with one or more intended features of the device along one or more selected axes.

In certain devices, said member is tapered and, correspondingly, the inner surface of said tip is also tapered so that the two can come together in a mating fashion resulting in an interference-fit.

In other devices the alignment guide on said member is provided remote from the end of same and, typically at a distance from said end equal to the inner length of said tip, further, the alignment guide on said tip is provided at the end nearest to said device body whereby when said tip is attached to said member the two alignment guides are brought together and can cooperate so that, via rotation of said device with respect to said tip, said tip is aligned with respect to said body. Yet more particularly said alignment guide on said tip comprises a rim provided at one end of same, the end that mates with said member, and the alignment guide on said member also comprises a rim provided on or about said member where the member mates with the tip. In certain embodiments said rims are of a complimentary, undulating nature and typically comprise at least one dip or at least one downward slope followed by at least one upward slope.

In other devices said device body that terminates in said member comprises a plurality of parts: a first part to which, or about which, said alignment member is attached or associated and a second part of circular cross-section which holds the said tip by friction (Interference Fit). In some embodiments said first part is bulbous or convex and has the alignment guide fashioned thereon or therein, further the second part is tapered or conical and has any angle between 0.5° and 20°, including all 0.1 intervals there between. However, those skilled in the art will appreciate that the selection of said angle is undertaken with a view to ensuring said tip can be attached to said device and then used for its intended purpose.

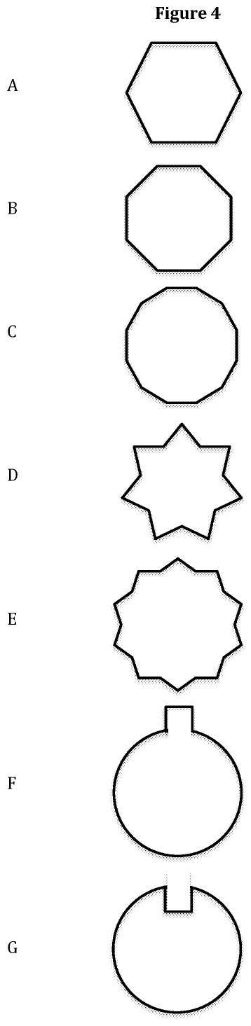

In other devices said abutment member projects from the outer surface of said tip and has a selected shape examples of which are given in FIG. 4. The selection of this shape is not critical to the working of the invention, rather, the shape is selected so that it can engage with an outline of the same shape provided in a lid of a container that is to be used in association therewith.

According to a second aspect, there is provided a removable tip for use with a hand-held device for dispending an agent and/or sampling and/or pipetting a fluid and/or receiving a sample for measurement purpose comprising: a structure that is at least partially hollow and whose inner hollow surface is sized and shaped to frictionally fit with a member provided on said device; and which is further provided with at least one alignment guide complimentary to at least one alignment guide provided on said device; and it is additionally provided with at least one outer abutment member provided on the outside of said tip.

Typically said tip is elongate and so too is said member, at least in the region where said tip and said member come together or mate. More particularly said tip includes a circular sectioned through bore which in some embodiments has a diameter that varies along its length i.e. it is conical or tapered.

According to a third aspect, there is provided a container adapted to facilitate the removal of tips from a hand-held device and also to receive same comprising: a body with a lid wherein the lid comprises at least one aperture whose boundary, at least in part, corresponds to the cross-sectional shape of at least one outer abutment member provided on the outside of said tip.

In certain embodiments the lid comprises at least one aperture whose boundary corresponds to the cross-sectional shape of a removable tip at the cross-section where said tip has at least one outer abutment member provided on the outside of same.

In certain embodiments said lid is made of a rigid or inflexible material whereby a tip placed in said aperture, such that the abutment member on same and the boundary corresponding to same in said aperture are aligned, can be held securely whilst the device to which said tip is attached can be rotated with respect to said tip to dislodge said tip from said device.

According to a fourth aspect, there is provided a hand-held device system comprising: a device body terminating in a member as afore described, a removable tip and a container as afore described.

According to a fifth aspect, there is provided a method for attaching a tip to a hand-held device, comprising the steps of:
providing a tip as afore described;
providing a hand-held device as afore described; and
attaching the tip to the device by applying a force to the tip and rotating the tip with respect to said device to bring about alignment of the alignment guides until a best fit is achieved.

According to a sixth aspect, there is provided a method for ejecting a tip from a hand-held device, comprising the steps of:
providing a tip as afore described;
providing a hand-held device as afore described;
providing a container as afore described; and
ejecting the tip from the hand-held device by inserting the tip into said container and aligning said abutment member on said tip with the boundary corresponding to same in said aperture then rotating said tip with respect to said device to eject the tip from the device.

According to a fifth aspect, there is provided a method for attaching and ejecting a tip from a hand-held device, comprising the steps of:
providing a tip as afore described;
providing a hand-held device as afore described;
providing a container as afore described;
attaching the tip to the device by applying a force to the tip and rotating the tip with respect to said device to bring about alignment of the alignment guides until a best fit is achieved; and
ejecting the tip from the hand-held device by inserting the tip into said container and aligning said abutment member on said tip with the boundary corresponding to same in said aperture then rotating said tip with respect to said device to eject the tip from the device.

In the claims which follow and in the preceding description of the invention, except where the context requires otherwise due to express language or necessary implication, the word “comprises”, or variations such as “comprises” or “comprising” is used in an inclusive sense i.e. to specify the presence of the stated features but not to preclude the presence or addition of further features in various embodiments of the invention.

All references, including any patent or patent application, cited in this specification are hereby incorporated by reference. No admission is made that any reference constitutes prior art. Further, no admission is made that any of the prior art constitutes part of the common general knowledge in the art.

Preferred features of each aspect of the invention may be as described in connection with any of the other aspects.

Other features of the present invention will become apparent from the following examples. Generally speaking, the invention extends to any novel one, or any novel combination, of the features disclosed in this specification (including the accompanying claims and drawings). Thus, features, integers, characteristics, compounds or chemical moieties described in conjunction with a particular aspect, embodiment or example of the invention are to be understood to be applicable to any other aspect, embodiment or example described herein, unless incompatible therewith.

Moreover, unless stated otherwise, any feature disclosed herein may be replaced by an alternative feature serving the same or a similar purpose.

Throughout the description and claims of this specification, the singular encompasses the plural unless the context otherwise requires. In particular, where the indefinite article is used, the specification is to be understood as contemplating plurality as well as singularity, unless the context requires otherwise.

An embodiment of the present invention will now be described by way of example only with reference to the following wherein:

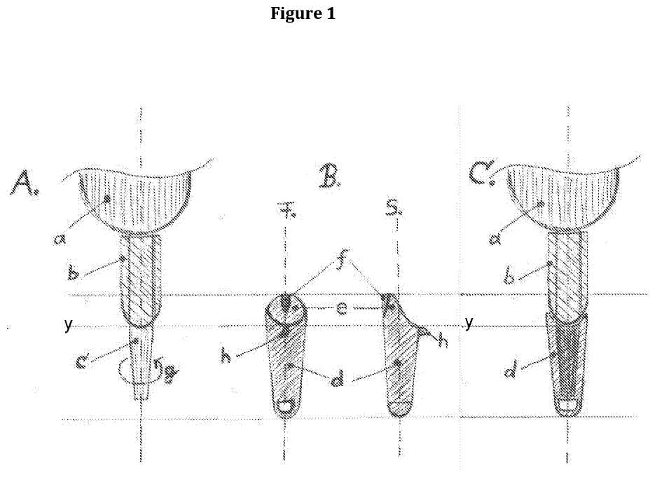

FIG. 1A is a side sectional view of a working end of a hand-held device according to the invention;

FIG. 1B is a rear and side view of a tip for use with a hand-held device according to the invention;

FIG. 1C is a side view of a working end of a hand-held device according to the invention after a tip has been attached thereto;

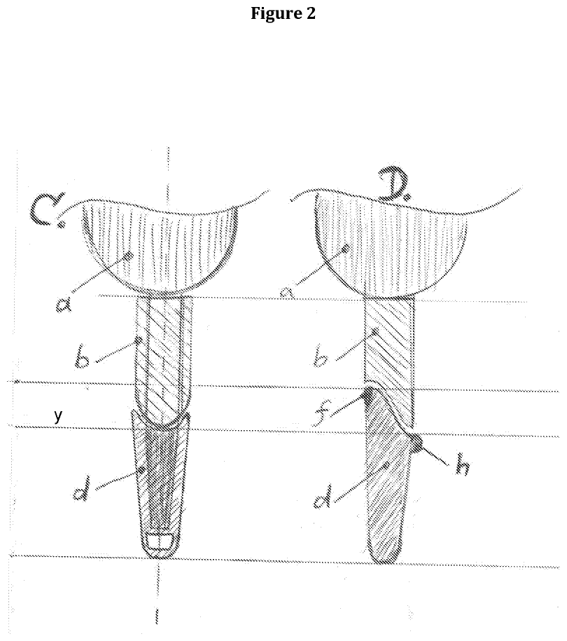

FIG. 2C is a side sectional view of a working end of a hand-held device according to the invention after a tip has been attached thereto; 2D is a front view of the device shown in FIG. 2C;

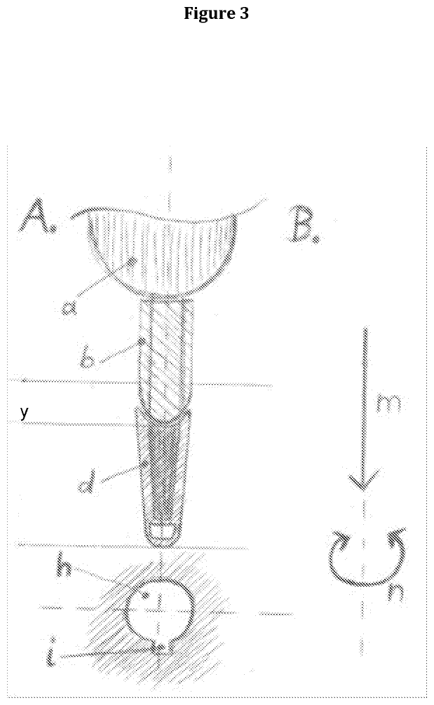

FIG. 3A shows alignment of the device of FIG. 1C with a partial view of a lid of a container according to the invention; 3B illustrates the requisite motion required to eject the tip form the device; and

FIG. 4 shows the optional cross-sectional shape of abutment members attached to the outer surface of said tip.

Referring now to the figures, and firstly to FIG. 1, there is illustrated the working end of a hand-held device, particularly, but not exclusively, of a type where a tip to be used on device needs to be correctly positioned and/or aligned. The working end comprises of a lower body to which there is attached, or integral therewith, a member b & c at least a part of which, usually the lower part c is of a circular cross-sectional shape. The size of part c is such that is can frictionally fit within a tip that is at least partially hollow or has a through-bore to be attached thereto. Parts b & c may constitute a single unit or may constitute two separate units that are brought together during manufacture of the device. Part b has provided on its lower end an alignment guide in the form of an undulating rim, this is best illustrated in FIG. 2. Parts a, b & c are held in a fixed position with respect to each other.

The removable tip for use with the device is shown in FIG. 1B. It is usually a hollow member and typically, but not exclusively, made from a disposable material. Its hollow body defines an inner bore whose shape corresponds to that of member c whereby the two can be held in a frictional manner when the tip is attached to the device. The upper or widest part of the tip has an alignment guide in the form of a rim, in the embodiment shown the rim sits on the end of the tip but it can be positioned about the tip provided that it is the same distance from the centre point x of the device/tip as is the alignment guide on part b so that the two alignment guides can be brought together.

The removable tip is also provided with an outer abutment member h having any desired cross-sectional shape. Exemplary cross-sectional shapes are shown in FIG. 4.

In use, a user positions the tip on member c and, given both are circular in cross-section, the device can be rotated with respect to the tip to bring about alignment of the alignment guides or rims to achieve a best fit. In this way a tip is not only attached to said device but fits on same in a correctly aligned fashion by simply bringing the two rims together in perfect alignment.

In FIGS. 1C, 2C and 2D the tip is shown attached to the device and with the alignment guides arranged in a complimentary position.

In FIG. 3 there is shown a tip attached to a device prior to its removal. In this figure the lid of a container for use with the device and tip is partially illustrated. The lid has at least one aperture usually centrally positioned, but there may be more than one aperture, and the outline of the aperture corresponds to the cross-sectional shape of the tip along axis y i.e. where the abutment member projects from the outer surface of said tip. In use, a user positions the tip in the aperture such that the abutment member h fits within the corresponding shape i of the aperture.

Those skilled in the art will therefore appreciate that a tip and device having complimentary alignment guides as herein described can inserted, aligned and ejected single-handedly by simply mating the two parts together.

### EXAMPLE

1: Typical Procedure for User to Attach Tip and Eject Tip.

In a typical but nor exclusive workflow the user will first pick up the device from a stand. Then the user opens the lid of the tip box. Then se user will move the receiving end of the device over the selected tip. Then the user will move the device down. The downwards action together with the shave of the tip and the device will cause the tip to rotate until the alignment of the tip relative to the device is achieved and the friction fit is achieved. The user will then move the device with the attached tip up and removing the tip from the tip box. The user will then perform any of such operations as pipetting, dispensing or a measurement by bringing the tip in contact or immersing the tip in a reagent, a fluid or a sample. After this operation the user typically attends to remove the tip. To remove the tip the user will open the lid of the tip ejector box. Then inserts the tip in the opening of the ejector box. At this opening the shape of the tip and the opening of the ejector box matches to hinder the rotation of the tip. The user will then rotate the device between 10 and 180 degree with the elector box fixed in its position. The rotation of the device will result in a downwards force of the tip relative to the device that disrupts the friction fit. As a result the tip is ejected from the device and falls into the container of the ejector box.

1. A hand-held device with a removable tip for dispending an agent and/or sampling a fluid and/or pipetting a fluid and/or receiving a sample for measurement purpose, comprising:
a device body terminating in a member that is circular in cross-section and sized and shaped to frictionally hold said tip and wherein said member is further provided with at least one alignment guide;
a removable tip that is at least partially hollow and whose inner surface is sized and shaped to frictionally fit with said member and which is further also provided with at least one alignment guide;
wherein said alignment guides comprise complimentary features that when brought together and rotated, one with respect to the other, result in alignment of said tip with respect to said body.

2. The device according to claim 1 wherein said tip is additionally provided with at least one abutment member located on the outside of said tip.

3. The device according to claim 1 wherein said device is selected from the group comprising: a laboratory device, a pipetting device, a photometer or spectrometer, a sensor, a biosensor or a diagnostic device.

4. The device according to claim 1 wherein said tip comprises a dispensing and/or sampling tip, a pipetting tip, or a tip for optical measurements such as but not limited to photometric, spectrometric or fluorometric measurements, or a sensor tip.

5. The device according to claim 4 wherein the tip is disposable or non-disposable.

6. The device according to claim 1 wherein said member is tapered.

7. The device according to claim 6 wherein the inner surface of said tip is also tapered.

8. The device according to claim 1 wherein said alignment guide on said member is provided remote from the end of same.

9. The device according to claim 8 wherein said alignment guide on said member is provided at a distance from said end equal to or less than the inner length of said tip.

10. The device according to claim 1 wherein the alignment guide on said tip is provided at the end nearest to said device body when said tip is in use.

11. The device according to claim 10 wherein said alignment guide on said tip comprises a rim provided at one end of same.

12. The device according to claim 1 wherein the alignment guide on said member comprises a rim provided on or about said member where the member mates with the tip.

13. The device according to claim 11 wherein said rims are of a complimentary, undulating nature and comprise at least one dip or at least one downward slope followed by at least one upward slope.

14. The device according to claim 1, wherein the alignment guides are of a complimentary undulating nature.

15. The device according to claim 14 wherein the alignment guides comprise at least one dip or at least one downward slope followed by at least one upward slope.

16. The device according to claim 1 wherein said device body comprises a plurality of parts: a first part to which, or about which, said alignment member is attached or associated and a second part of circular cross-section which frictionally holds said tip.

17. The device according to claim 16 wherein said first part is bulbous or convex and has the alignment guide fashioned thereon or therein.

18. The device according to claim 15 wherein the second part is tapered or conical.

19. The device according to claim 18 wherein said second part has any angle between 0.5° and 20°, including all 0.1 intervals there between.

20. The device according to claim 1 wherein said abutment member projects from the outer surface of said tip and has a selected shape.

21. A removable tip for use with a hand-held device for dispending an agent and/or sampling a fluid comprising: a structure that is at least partially hollow and whose inner hollow surface is sized and shaped to frictionally fit with a member provided on said device; and which is further provided with at least one alignment guide complimentary to at least one alignment guide provided on said device.

22. The tip according to claim 21 wherein said tip is additionally provided with at least one abutment member located on the outside of said tip.

23. The tip according to claim 21 or 22 wherein said tip is elongate.

24. The tip according to claim 21 wherein said tip includes a circular sectioned bore

25. The tip according claim 24 wherein said bore has a diameter that varies along its length i.e. it is conical or tapered.

26. A container adapted to facilitate the removal of tips from a hand-held device and also to receive same comprising: a body with a lid wherein the lid comprises at least one aperture whose boundary, at least in part, corresponds to the cross-sectional shape of at least one outer abutment member provided on the outside of said tip.

27. The container according to claim 25 wherein the lid comprises at least one aperture whose boundary corresponds to the cross-sectional shape of a removable tip at the cross-section where said tip has at least one outer abutment member provided on the outside of same.

28. The container according to claim 26 wherein said lid is made of a rigid or inflexible material.

29. A hand-held device system comprising: a device according to claim 1, a removable tip and a container.

30. A method for attaching a tip to a hand-held device, comprising the steps of:
providing a tip as afore described;
providing a hand-held device as afore described; and
attaching the tip to the device by applying a force to the tip and rotating the tip with respect to said device to bring about alignment of the alignment guides until a best fit is achieved.

31. A method for ejecting a tip from a hand-held device, comprising the steps of:
providing a tip as afore described;
providing a hand-held device as afore described;
providing a container as afore described; and
ejecting the tip from the hand-held device by inserting the tip into said container and aligning said abutment member on said tip with the boundary corresponding to same in said aperture then rotating said tip with respect to said device to eject the tip from the device.

32. A method for attaching and ejecting a tip from a hand-held device, comprising the steps of:
providing a tip as afore described;
providing a hand-held device as afore described;
providing a container as afore described;
attaching the tip to the device by applying a force to the tip and rotating the tip with respect to said device to bring about alignment of the alignment guides until a best fit is achieved; and
ejecting the tip from the hand-held device by inserting the tip into said container and aligning said abutment member on said tip with the boundary corresponding to same in said aperture then rotating said tip with respect to said device to eject the tip from the device.
